(19) United States
(12) Patent Application Publication
(10) Pub. No.: US 2015/0236346 A1
(43) Pub. Date: Aug. 20, 2015

(54) POSITIVE ELECTRODE ACTIVE MATERIAL, PREPARING METHOD THEREOF, POSITIVE ELECTRODE INCLUDING THE SAME, AND LITHIUM SECONDARY BATTERY INCLUDING THE SAME

(71) Applicant: Samsung SDI Co., Ltd., Yongin-si (KR)

(72) Inventors: Jun-Seok Park, Yongin-si (KR); Jay-Hyok Song, Yongin-si (KR); Chang-Wook Kim, Yongin-si (KR); Yong-Chan You, Yongin-si (KR); Sun-Ho Kang, Yongin-si (KR)

(21) Appl. No.: 14/565,287

(22) Filed: Dec. 9, 2014

(30) Foreign Application Priority Data
Feb. 17, 2014 (KR) 10-2014-0018035

(51) Int. Cl. H01M 4/505; H01M 4/04; H01M 4/58; H01M 4/525; H01M 10/052

(52) U.S. Cl. CPC H01M 4/505; H01M 4/525; H01M 10/052; H01M 4/5825; H01M 4/0471; H01M 4/0497; H01M 2220/30

(57) ABSTRACT

Disclosed are a positive electrode active material including a compound represented by Formula 1 and also including about 3% by mole to about 10% by mole of chromium,

xLi₂MnO₃-(1−x)Li_{y}Ni_{A}Mn_{B}Co_{C}M_{D}O₂ [Formula 1]

wherein 0<x≦0.8, 0.7≦y≦1.3, 0<A≦0.5, 0<B≦0.8, 0<C≦0.5, and 0≦D≦0.20, and M is one or more metals selected from the group includes titanium (Ti), vanadium (V), iron (Fe), copper (Cu), aluminum (Al), magnesium (Mg), zirconium (Zr), and boron (B); a positive electrode for a lithium secondary battery including the positive electrode active material; and a lithium secondary battery including the positive electrode.

### RELATED APPLICATION

Any and all priority claims identified in the Application Data Sheet, or any correction thereto, are hereby incorporated by reference under 37 CFR 1.57. For example, this application claims priority to and the benefit of Korean Patent Application No. 10-2014-0018035, filed on Feb. 17, 2014, the disclosure of which is incorporated herein by reference in its entirety.

### BACKGROUND

1. Field

The present disclosure relates to a positive electrode active material and a method of preparing the positive electrode active material. The present disclosure also relates to a positive electrode for a lithium secondary battery including the positive electrode active material, and a lithium secondary battery including the positive electrode for a lithium secondary battery.

2. Description of the Related Technology

Lithium secondary batteries have been increasingly used in cellular phones, camcorders, and notebook computers. One important factor affecting the capacities of these batteries is the positive electrode active material. The electrochemical characteristics of the positive electrode active material determines whether batteries may be used for a long time at high rates and whether they can maintain initial capacities after multiple charging and discharging cycles.

Lithium nickel composite oxides as well as lithium cobalt oxides are widely used as positive electrode active materials for lithium secondary batteries. However, current lithium secondary batteries using the lithium nickel composite oxides have voltage reduction phenomenon and poor lifetime characteristics.

### SUMMARY OF CERTAIN INVENTIVE ASPECTS

An aspect of the present disclosure provides a positive electrode active material, a method of preparing the positive electrode active material, and a positive electrode for a lithium secondary battery including the positive electrode active material.

Another aspect of the present disclosure provides a lithium secondary battery which not only improves lifetime characteristics, but also inhibits a voltage reduction phenomenon by employing the positive electrode.

Additional aspects will be set forth in part in the description which follows and, in part, will be apparent from the description, or may be learned by practice of the presented embodiments.

In some embodiments, the positive electrode active material includes a compound represented by Formula 1 and about 3% by mole to about 10% by mole of chromium:

xLi₂MnO₃-(1−x)Li_{y}Ni_{A}Mn_{B}Co_{C}M_{D}O₂ [Formula 1]
wherein 0<x≦0.8, 0.7≦y≦1.3, 0<A≦0.5, 0<B≦0.8, 0<C≦0.5, and 0≦D≦0.20, and M is at least one metal selected from the group consisting of titanium (Ti), vanadium (V), iron (Fe), copper (Cu), aluminum (Al), magnesium (Mg), zirconium (Zr), and boron (B).

In some embodiments, 0<x≦0.5, 0.9≦y≦1.1, 0<A≦0.44, 0<B≦0.33, 0<C≦0.33, and 0≦D≦0.10 in Formula 1.

In some embodiments, 0<A≦0.22, 0<B≦0.66, 0<C≦0.20, and 0≦D≦0.10.

In some embodiments, the compound represented by Formula 1 is 0.5Li₂MnO₃-0.5LiNi_{0.44}Co_{0.24}Mn_{0.32}O₂ or 0.4Li₂MnO₃-0.6LiNi_{0.33}Co_{0.33}Mn_{0.33}O₂.

In some embodiments, the compound represented by Formula 1 is 0.4Li₂MnO₃-0.6LiNi_{0.33}Co_{0.33}Mn_{0.33}O₂.

In some embodiments, the positive electrode active material includes about 3% by mole of chromium.

In some embodiments, the positive electrode active material includes about 7% by mole of chromium.

In some embodiments, the positive electrode active material includes about 10% by mole of chromium.

In some embodiments, the positive electrode active material has a layered lattice structure with equal lattice constants (a) and (b) between about 2.85300 Å to about 2.85900 Å.

In some embodiments, the positive electrode active material includes primary particles having an average particle diameter from about 10 nm to about 300 nm.

In some embodiments, the positive electrode active material includes secondary particles having an average particle diameter from about 3 μm to about 5 μm.

In some embodiments, the method of preparing a positive electrode active material includes:
mixing a composite precursor of Formula 2, a lithium compound, and a chromium compound; and

NiₐMn_{b}Co_{c}M_{d}(OH)₂ Formula 2
wherein 0<a≦0.5, 0<b≦0.8, 0<c≦0.5, and 0≦d≦0.20, and M is at least one metal selected from the group consisting of titanium (Ti), vanadium (V), iron (Fe), copper (Cu), aluminum (Al), magnesium (Mg), zirconium (Zr), and boron (B); and
heat-treating the mixture to obtain the positive electrode active material comprising a compound represented by Formula 1 and about 3% by mole to about 10% by mole of chromium:

xLi₂MnO₃-(1−x)Li_{y}Ni_{A}Mn_{B}Co_{C}M_{D}O₂ [Formula 1]
wherein 0<x≦0.8, 0.7≦y≦1.3, 0<A≦0.5, 0<B≦0.8, 0<C≦0.5, and 0≦D≦0.20, and M is one or more metals selected from the group consisting of titanium (Ti), vanadium (V), iron (Fe), copper (Cu), aluminum (Al), magnesium (Mg), zirconium (Zr), and boron (B).

In some embodiments, the composite precursor represented by Formula 2 is prepared by the method comprising:

mixing a nickel precursor, a cobalt precursor, a manganese precursor, a metal (M) precursor, and a solvent to prepare a precursor mixture; and

mixing the precursor mixture with a base and performing a coprecipitation reaction on a resulting mixture.

In some embodiments, the chromium compound is at least one of chromic nitrate, chromium chloride, and chromium oxide.

In some embodiments, the mixture containing the precursor mixture and the base has a pH value range from about 7 to about 9.

In some embodiments, the mixture containing the precursor mixture and the base has a pH value of about 8.

In some embodiments, the heat-treating of the mixture is conducted at a temperature from about 700° C. to about 950° C.

In some embodiments, the heat-treating of the mixture is conducted at a temperature from about 750° C. to about 900° C.

In some embodiments, the positive electrode for a lithium secondary battery, the positive electrode comprising the positive electrode active material described herein.

In some embodiments, the lithium secondary battery includes
a positive electrode;
a negative electrode; and
a separator disposed between the positive electrode and the negative electrode, wherein the positive electrode is the positive electrode for a lithium secondary battery described herein.

According to another aspect of the present disclosure, there is provided a positive electrode for a lithium secondary battery including the above-described positive electrode active material.

According to another aspect of the present disclosure, there is provided a lithium secondary battery including the above-described positive electrode.

### BRIEF DESCRIPTION OF THE DRAWINGS

FIG. 1 is a schematic diagram illustrating a lithium secondary battery.

FIGS. 2 to 5 are scanning electron microscope photographs of positive electrode active materials obtained according to Example 5 and Comparative Example 1.

FIG. 6 is a graph illustrating X-ray diffraction analysis results for positive electrode active materials obtained according to Examples 1 and 3 and a positive electrode active material obtained according to Comparative Example 1.

FIG. 7 shows specific capacity variations in coin cells manufactured according to Manufacturing Examples 3 to 5 and Comparative Manufacturing Examples 1 to 4.

FIG. 8 shows nominal voltage variations in coin cells respectively prepared according to Manufacturing Examples 1 to 3 and Comparative Manufacturing Examples 1, 3, and 4.

FIGS. 9 and 10 show charge/discharge test results for coin cells prepared according to Manufacturing Example 3 and Comparative Manufacturing Example 1.

### DETAILED DESCRIPTION OF CERTAIN INVENTIVE EMBODIMENTS

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

Hereinafter, a positive electrode active material, a method of preparing the positive electrode active material, a positive electrode for a lithium secondary battery including the positive electrode active material, and a lithium secondary battery employing the positive electrode according to embodiments of the present disclosure will be described more in detail.

One aspect of the present disclosure relates to a positive electrode active material including a compound represented by Formula 1 and about 3% by mole to about 10% by mole of chromium:

xLi₂MnO₃-(1−x)Li_{y}Ni_{A}Mn_{B}Co_{C}M_{D}O₂ [FORMULA 1]

wherein 0<x≦0.8, 0.7≦y≦1.3, 0<A≦0.5, 0<B≦0.8, 0<C≦0.5, and 0≦D≦0.20, and M is at least one metals selected from the group consisting of titanium (Ti), vanadium (V), iron (Fe), copper (Cu), aluminum (Al), magnesium (Mg), zirconium (Zr), and boron (B).

The above-described positive electrode active material of Formula 1 has a problem that a nominal voltage decreases due to a phase transition of Li₂MnO₃ into a LiMn₂O₄ spinel structure as charge and discharge are repeatedly performed. “A drop in the nominal voltage (voltage drop)” is a phenomenon in which a discharge nominal voltage decreases as a phase transition of Li₂MnO₃ into the spinel structure occurs during charging as represented by the following Reaction Formula:

Li₂MnO₃→Li_{( 2-x)}MnO_{(3-x/2)}+xLi⁺+(x/4)O₂+xe⁻

In the reaction formula above, 0<x<2.

Chromium is added to the above-described compound represented by Formula 1 as much as about 1% by mole to about 15% by mole, about 3% by mole to about 10% by mole, or about 5% by mole to about 8% by mole so that the positive electrode active material prevents a phase transition of Li₂MnO₃. As a result, a nominal voltage reduction phenomenon of (1−x)Li₂MnO_{3+xLi}(Ni_{A}Co_{B}Mn_{C})O₂ being the active material is prevented during the repeated battery cycles.

In some embodiments, in Formula 1, 0<A≦0.22, 0<B≦0.66, 0<C≦0.20, and 0≦D≦0.10.

In some embodiments, in Formula 1, 0<a≦0.15, 0<b≦0.5, 0<c≦0.10, and 0≦d≦0.05.

In some embodiments, the compound represented by Formula 1 in the positive electrode active material is 0.5Li₂MnO₃-0.5LiNi_{0.44}Co_{0.24}Mn_{0.32}O₂ or 0.4Li₂MnO₃-0.6LiNi_{0.33}Co_{0.33}Mn_{0.33}O₂.

Although formation of an additional phase in a chromium-added positive electrode active material is not observed from an X-ray diffraction analysis spectrum, a lattice constant (a) increases as the content of chromium increases. The chromium-containing positive electrode active material has a layered lattice structure, and lattice constants (a) and (b) thereof are equal and range from about 2.85000 Å to about 2.88000 Å, from about 2.85300 Å to about 2.85900 Å, from about 2.85515 Å to about 2.85767 Å, or from about 2.85600 Å to about 2.85700 Å.

Primary particles of the positive electrode active material may have an average particle diameter from about 10 nm to about 300 nm, from about 20 nm to about 280 nm, from about 30 nm to about 250 nm, from about 50 nm to about 200 nm. In some embodiments, the primary particles of the positive electrode active material may have an average particle diameter of about 50 nm, about 75 nm, about 100 nm, about 125 nm, about 150 nm, about 175 nm, about 200 nm, or any combinations thereof In some embodiments, the maximum average particle diameter of the primary particles of the positive electrode active material is larger than an average particle diameter of primary particles of a compound represented by Formula 1 without chromium being added.

In some embodiments, the secondary particles of a positive electrode active material may have an average particle diameter from about 1 μm to about 10 μm , from about 2 μm to about 8 μm, or from about 3 μm to about 5 μm. When the secondary particles of the positive electrode active material are in the average particle diameter range, lithium secondary batteries having improved lifetime characteristics and capacity characteristics may be manufactured.

The content of chromium in the positive electrode active material may be confirmed through an inductively coupled plasma (ICP) analysis. The content of chromium may be from about 1% by mole to about 10% by mole, from about 2% by mole to about 9% by mole, from about 2.82% by mole to about 8.67% by mole, from 3% by mole to about 8% by mole, or from about 4% by mole to about 7% by mole when performing the ICP analysis.

In Formula 1, 0<A≦0.22, 0<B≦0.66, 0<C≦0.20, and 0≦D≦0.10.

The positive electrode active material may have a pellet density between about 2.4 g/cc to about 2.6 g/cc.

Hereinafter, a method of preparing a positive electrode active material, according to an embodiment of the present disclosure, will be explained.

A positive electrode active material that is represented by the above-described Formula 1 and includes about 3% by mole to about 10% by mole of chromium may be obtained by mixing a precursor represented by Formula 2, a lithium compound, and a chromium compound to obtain a mixture, and heat-treating the mixture:

NiₐMn_{b}Co_{c}M_{d}(OH)₂ [Formula 2]

where 0<a≦0.5, 0<b≦0.8, 0<c≦0.5, and 0≦d≦0.20, and M is one or more metals selected from the group consisting of Ti, V, Fe, Cu, Al, Mg, Zr, and B.

Examples of the lithium compound may include lithium hydroxide, lithium fluoride, lithium carbonate, and mixtures thereof. The content of the lithium compound is stoichiometrically controlled to obtain the suitable composition of the positive electrode active.

Examples of the chromium compound may include one or more selected from chromic nitrate, chromium oxide, and chromium chloride. The content of the chromium compound is stoichiometrically controlled to obtain the suitable composition of the positive electrode active material, and the chromium compound has a content range from about 1% by mole to about 15% by mole, from about 2% by mole to about 12.5% by mole, from about 3% by mole to about 10% by mole, or from about 5% by mole to about 8% by mole. In some embodiments, the chromium compound has a content of at least about 1% by mole, 2% by mole, 3% by mole, 4% by mole, 5% by mole, 6% by mole, 7% by mole, 8% by mole, 9% by mole, 10% by mole, or any combinations thereof. The voltage reduction-inhibiting effect does not occur if the content of chromium is less than about 3% by mole, and the capacity and rate characteristics of electrochemical characteristics of the positive electrode active material may decrease if the content of chromium is greater than about 10% by mole.

The heat-treating of the mixture is conducted at a temperature from about 700° C. to about 950° C. or from about 750° C. to about 900° C. In some embodiments, the heat-treating of the mixture is conducted at a temperature of about 700° C., about 750° C., about 800° C., about 850° C., about 900° C., about 950° C., or any ranges there between . When the heat-treating is carried out at the temperature range, lithium composite oxides are easily formed. The heat-treating may be performed under an air atmosphere.

In some embodiments, the temperature increasing rate during the heat-treating is controlled to be with the range of about 5° C./min to about 10° C./min.

After the heat-treating, a resulting material is sieved using a sieve having a mesh size of about 200 meshes to about 350 meshes so that a positive electrode active material may be obtained.

The precursor represented by Formula 2 is mixed with a nickel precursor, a cobalt precursor, a manganese precursor, a metal (M) precursor, and a solvent to obtain a precursor mixture.

In some embodiments, a pH-controlling agent is added to the precursor mixture, and a coprecipitation reaction is performed on a resulting mixture to obtain a precursor of Formula 2.

The pH-controlling agent plays a role of helping the formation of a precipitate by controlling the mixture to have a pH value range from about 7 to about 9. Examples of the pH-controlling agent may include ammonia water, sodium carbonate, and sodium hydroxide.

In some embodiments, a chelating agent may be added to the mixture.

The chelating agent may play a role of controlling a precipitate-forming reaction rate, and examples of the chelating agent may include ammonium carbonate and ammonia water.

Examples of the metal (M) precursors may include metal M sulfates, metal M nitrates, and metal M chlorides.

Examples of the M precursor may include an M sulfate, an M nitrate, and an M chloride., wherein M is one or more metals selected from the group consisting of titanium (Ti), vanadium (V), iron (Fe), copper (Cu), aluminum (Al), magnesium (Mg), zirconium (Zr), and boron (B).

Examples of the nickel precursor may include nickel sulfate, nickel nitrate, and nickel chloride, and examples of the cobalt precursor may include cobalt sulfate, cobalt nitrate, and cobalt chloride.

Examples of the manganese precursor may include manganese sulfate, manganese nitrate, and manganese chloride.

The content of the M precursor is stoichiometrically controlled so that a precursor of Formula 2 may be obtained.

Examples of the solvent may include ethanol and deionized water. The content of the solvent is from about 300 parts by weight to about 1,000 parts by weight based on 100 parts by weight of the nickel precursor. When the content of the solvent is in the above-described range, a mixture in which respective components are uniformly mixed may be obtained.

In some embodiments, a precipitate is obtained from the coprecipitation, the precipitate is cleaned using pure water, and the cleaned precipitate is dried to obtain a composite precursor of Formula 2.

When the positive electrode active material is used, a nominal voltage reduction phenomenon is inhibited even under repeated charge and discharge conditions, and an electrode having excellent lifetime characteristics may be manufactured. A lithium secondary battery having improved charge/discharge characteristics, rate characteristics, and lifetime characteristics may be manufactured using such an electrode.

Hereinafter, a process of manufacturing a lithium secondary battery by using the positive electrode active material will be explained. For example, a method of manufacturing a lithium secondary battery including a positive electrode, a negative electrode, a lithium salt-containing nonaqueous electrolyte, and a separator will be described according to an embodiment of the present disclosure.

The positive electrode and the negative electrode are manufactured by respectively coating and drying a positive electrode active material layer-forming composition and a negative electrode active material layer-forming composition on a current collector.

The positive electrode active material layer-forming composition is prepared by mixing a positive electrode active material, a conducting agent, a binder, and a solvent. A positive electrode active material, including a compound which contains about 3% by mole to about 10% by mole of chromium and is represented by Formula 1, may be used as the positive electrode active material.

The binder as a component aiding a bond between an active material and a conducting agent or other materials and a bond to a current collector is added in an amount of about 1 part by weight to about 50 part by weight, e.g., about 2 parts by weight to about 5 parts by weight based on 100 parts by weight of the total positive electrode active material weight. Non-limiting examples of such a binder may include polyvinylidene difluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene terpolymer (EPDM), sulfonated EPDM, styrene butadiene rubber, fluoro rubber, and various copolymers. When the binder has the above-described amount range, binding strength of the active material layer to the current collector is good.

Materials for conducting agents, which have electrical conductivities while they do not cause chemical changes in relevant batteries, are not particularly limited. Examples of the conducting agent may include: graphite such as natural graphite and artificial graphite; carbonaceous materials such as carbon black, acetylene black, Ketjen black, channel black, furnace black, lamp black, and summer black; conductive fibers such as carbon fiber and metal fiber; metal powders such as aluminum powder and nickel powder; conductive whisker such as a zinc oxide and a potassium titanate; conductive metal oxides such as titanium oxide; and conductive materials such as polyphenylene derivatives.

The conducting agent is contained in an amount from about 2 parts by weight to about 5 parts by weight based on 100 parts by weight of the total positive electrode active material weight. When the conducting agent is contained in the amount range, a finally obtained positive electrode has excellent electrical conductivity.

Non-limiting examples of the solvent may include N-methylpyrrolidone.

The solvent is contained in an amount from about 1 part by weight to about 10 parts by weight based on 100 parts by weight of the positive electrode active material. When the solvent is contained in the amount range, an operation for forming an active material layer is easily carried out.

Materials for the positive electrode current collector, which have a thickness range from about 3 μm to about 500 μm and high electrical conductivities while they do not cause chemical changes in relevant batteries, are not particularly limited. Examples of the positive electrode current collector may include stainless steel, aluminum, nickel, titanium, heat-treated carbon, or materials obtained by treating the surface of aluminum or stainless steel with carbon, nickel, titanium, or silver. The positive electrode current collector may have minute irregularities formed on its surface to increase adhesive strength of the positive electrode active material, and the positive electrode current collector may be formed in various forms including a film, a sheet, a foil, a net, a porous body, a foam, a non-woven fabric body, etc.

Separately from the positive electrode current collector, a negative electrode active material, a binder, a conducting agent, and a solvent are mixed to prepare a negative electrode active material layer-forming composition.

Materials that are capable of performing occlusion and release of lithium ions may be used as the negative electrode active material. Non-limiting examples of the negative electrode active material may include: carbonaceous materials such as graphite and carbon; lithium metal; lithium metal alloys; and silicon oxide-based materials. A negative electrode active material according to an embodiment of the present disclosure may include silicon oxide.

In some embodiments, the binder is added in an amount from about 1 part by weight to about 50 parts by weight based on 100 parts by weight of the total negative electrode active material weight. Non-limiting examples of such a binder may include the same type of materials as the positive electrode.

The conducting agent is contained in an amount range from about 1 part by weight to about 5 parts by weight based on 100 parts by weight of the total negative electrode active material weight. When the conducting agent is contained in the amount range, a finally obtained electrode may have excellent electrical conductivity.

The solvent is contained in an amount ranging from about 1 part by weight to about 10 parts by weight based on 100 parts by weight of the total negative electrode active material weight. When the solvent is contained in the amount range described herein, the operation for forming a negative electrode active material layer is easily carried out.

The same type of materials as those used when manufacturing the positive electrode may be used as the conducting agent and solvent.

The negative electrode current collector is generally manufactured to a thickness ranging from about 3 μm to about 500 μm.

Materials that have electrical conductivities while they do not cause chemical changes in relevant batteries as such a negative electrode current collector are not particularly limited. Examples of the negative electrode current collector may include copper, stainless steel, aluminum, nickel, titanium, heat-treated carbon, materials obtained by treating the surface of copper or stainless steel with carbon, nickel, titanium, or silver, and aluminum-cadmium alloys. Further, as in the positive electrode current collector, the negative electrode current collector may have minute irregularities formed on its surface to strengthen a binding force of the negative electrode active material, and the negative electrode current collector may be used in various forms including a film, a sheet, a foil, a net, a porous body, a foam, a non-woven fabric body, etc.

In some embodiments, a separator is interposed between a positive electrode and a negative electrode that are manufactured according to the above-described processes.

The separator generally having a pore diameter from about 0.01 μm to about 10 μm and a thickness from about 5 μm to about 300 μm may be used. Specific examples of the separator may include: olefin-based polymers such as polypropylene and polyethylene; or sheets or non-woven fabrics made of glass fiber. When a solid electrolyte such as a polymer may be used as an electrolyte, the solid electrolyte may also function as the separator.

The lithium salt-containing nonaqueous electrolyte includes a nonaqueous electrolytic solution and lithium. Examples of the lithium salt-containing nonaqueous electrolyte may include a nonaqueous electrolytic solution, an organic solid electrolyte, and an inorganic solid electrolyte.

Non-limiting examples of the nonaqueous electrolytic solution may include aprotic organic solvents such as N-methyl-2-pyrrolidinone, propylene carbonate, ethylene carbonate, butylenes carbonate, dimethyl carbonate, diethyl carbonate, gamma-butyrolactone, 1,2-dimethoxy ethane, 2-methyl tetrahydrofuran, dimethyl sulfoxide, 1,3-dioxolane, formamide, dimethylformamide, dioxolane, acetonitrile, nitromethane, methyl formate, methyl acetate, trimester phosphate, trimethoxy methane, sulfolane, methyl sulfolane, 1,3-dimethyl-2-imidazolidinone, propylene carbonate derivatives, ether, methyl propionate, and ethyl propionate.

Non-limiting examples of the organic solid electrolyte may include polyethylene derivatives, polyethylene oxide derivatives, polypropylene oxide derivatives, ester phosphate polymer, polyvinyl alcohol, and polyvinylidene fluoride.

Non-limiting examples of the inorganic solid electrolyte may include lithium nitrides, lithium halides, lithium sulfates, etc. such as Li₃N, LiI, Li₅NI₂, Li₂N—LiI—LiOH, Li₂SiS₃, Li₄SiO₄, Li₄SiO₄—LiI—LiOH, and Li₃PO₄—Li₂S—SiS₂.

In some embodiments, the lithium salts are materials which are dissolved well into the lithium salt-containing nonaqueous electrolyte, and non-limiting examples of the lithium salt may include LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, low aliphatic lithium carboxylate, and tetraphenyl lithium borate.

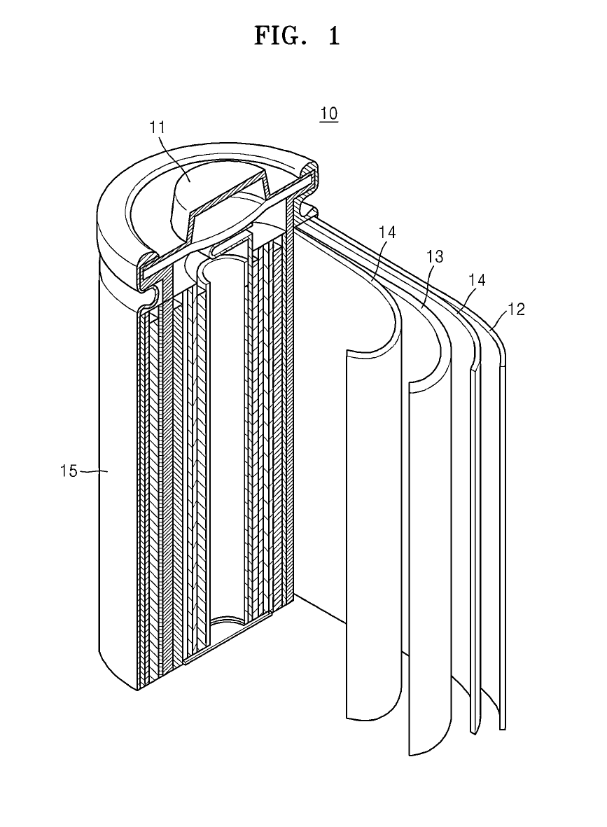

FIG. 1 is a schematic drawing in which a representative structure of a lithium secondary battery 10 is schematically illustrated.

Referring to FIG. 1, the lithium secondary battery 10 consists of main parts including a positive electrode 13, a negative electrode 12, a separator 14 disposed between the positive electrode 13 and the negative electrode 12, an electrolyte, which is not illustrated and impregnates the positive electrode 13, the negative electrode 12 and the separator 14, a battery case 15, and a cap assembly 11 which seals the battery case 15. The lithium secondary battery 10 may be constructed by sequentially disposing the positive electrode 13, the negative electrode 12 and the separator 14, and then housing the disposed positive electrode 13, the negative electrode 12 and the separator 14 in the battery case when they are rolled. The battery case 15 is sealed along with the cap assembly 11 to complete the manufacture of the lithium secondary battery 10.

Hereinafter, examples will be described. However, the scope and spirit of the present disclosure is not particularly limited to the examples.

### EXAMPLE 1

### Preparation of Positive Electrode Active Material

100 g of nickel(II) sulfate hexahydrate (NiSO₄-6H₂O), 107 g of cobalt(II) sulfate heptahydrate (CoSO₄-7H₂O), and 193 g of manganese(II) sulfate monohydrate (MnSO₄—H₂O) were dissolved in 617 g of water to prepare a precursor mixture.

The precursor mixture and ammonia water (NH₄OH) were put into a reaction vessel, the mixture in the reaction vessel was stirred to a rate of 900 rpm, and the reaction vessel was maintained at a temperature of 40° C.

Ammonia water was added to the mixture to perform a coprecipitation reaction process, wherein 29.08 parts by weight of ammonia water were injected based on 100 parts by weight of the precursor mixture, and the pH of a resulting solution of the precursor mixture and ammonia water was automatically controlled by a pH controller so that the solution had a pH value of about 8.

A precipitate was formed from an overflowing slurry-state mixture. After the obtained precipitate was cleaned using purified water, the cleaned precipitate was dried in a vacuum at a temperature of 20° C. to 25° C. so that the precursor Ni_{0.22}Co_{0.2}Mn_{0.66}(OH)₂ was prepared.

100 g of the precursor Ni_{0.22}Co_{0.2}Mn_{0.66}(OH)₂ were mixed with 47.675 g of Li₂CO₃ and 13.903 g of chromium(III) nitrate nonahydrate (Cr(NO₃)₃.9H₂O), and the mixture underwent calcination at about 750° C. for 10 hours to obtain 0.4Li₂MnO₃-0.6LiNi_{0.33}Co_{0.33}Mn_{0.33}O₂.

100 g of the coprecipitate Ni_{0.22}Co_{0.2}Mn_{0.66}(CO₃)₂ were mixed with 47.675 g of Li₂CO₃ and 13.903 g of chromium(III) nitrate nonahydrate (Cr(NO₃)₃.9H₂O), and the mixture underwent calcination at about 750° C. for 10 hours to obtain 0.4Li₂MnO₃-0.6LiNi_{0.33}Co_{0.33}Mn_{0.33}O₂ in which about 3% by mole of chromium was added.

### EXAMPLE 2

### Preparation of Positive Electrode Active Material

The preparation of the positive electrode active material was performed using the same method described in Example 1 except that the content of chromium(III) nitrate nonahydrate (Cr(NO₃)₃.9H₂O) was changed to 30.557 g, so as to obtain 0.4Li₂MnO₃-0.6LiNi_{0.33}Co_{0.33}Mn_{0.33}O₂ in which about 7% by mole of chromium was added.

### EXAMPLE 3

### Preparation of Positive Electrode Active Material

The preparation of a positive electrode active material was performed using the same method described in Example 1 except that the content of chromium(III) nitrate nonahydrate (Cr(NO₃)₃.9H₂O) was changed from 13.903 g to 43.989 g to obtain 0.4Li₂MnO₃-0.6LiNi_{0.33}Co_{0.33}Mn_{0.33}O₂ in which about 10% by mole of chromium was added.

### EXAMPLES 4 to 6

### Preparation of Positive Electrode Active Materials

The preparation of positive electrode active materials was performed using the same method described in Examples 1, 2, and 3 except that the calcination temperature was changed to 900° C., so as to obtain 0.4Li₂MnO₃-0.6LiNi_{0.33}Co_{0.33}Mn_{0.33}O₂ in which about 3% by mole of chromium was added, 0.4Li₂MnO₃-0.6LiNi_{0.33}Co_{0.33}Mn_{0.33}O₂ in which about 7% by mole of chromium was added, and 0.4Li₂MnO₃-0.6LiNi_{0.33}Co_{0.33}Mn_{0.33}O₂ in which about 10% by mole of chromium was added.

### COMPARATIVE EXAMPLE 1

### Preparation of Positive Electrode Active Material

The preparation of a positive electrode active material was performed using the same method described in Example 1 except that chromium(III) nitrate nonahydrate (Cr(NO₃)₃.9H₂O) was not used, so as to obtain 0.4Li₂MnO₃-0.6LiNi_{0.33}Co_{0.33}Mn_{0.33}O₂.

### COMPARATIVE EXAMPLE 2

### Preparation of Positive Electrode Active Material

The preparation of a positive electrode active material was performed using the same method described in Example 4 except that chromium(III) nitrate nonahydrate (Cr(NO₃)₃.9H₂O) was not used, so as to obtain 0.4Li₂MnO₃-0.6LiNi_{0.33}Co_{0.33}Mn_{0.33}O₂.

### COMPARATIVE EXAMPLES 3 and 4

### Preparation of Positive Electrode Active Materials

The preparation of positive electrode active materials was performed using the same method described in Example 1 except that the content of chromium(III) nitrate nonahydrate (Cr(NO₃)₃.9H₂O) was changed to 63.327 g and 91.164 g respectively, so as to obtain 0.4Li₂MnO₃-0.6LiNi_{0.33}Co_{0.33}Mn_{0.33}O₂ in which about 13% by mole of chromium was added and 0.4Li₂MnO₃-0.6LiNi_{0.33}Co_{0.33}Mn_{0.33}O₂ in which about 16% by mole of chromium was added.

### MANUFACTURING EXAMPLE 1

### Manufacturing of Coin Cell

A 2032 coin cell was manufactured using the positive electrode active material prepared in Example 1, as follows:

A mixture of 92 g of the positive electrode active material prepared according to Example 1, 4 g of polyvinylidene fluoride, 106.21 g of N-methylpyrrolidone being a solvent, and 4 g of carbon black as a conducting agent was deaerated and uniformly dispersed by using a mixer to prepare slurry for forming a positive electrode active material layer.

The slurry prepared according to the above-described process was coated on an aluminum foil using a doctor blade so as to form a thin electrode plate, and the thin electrode plate was dried at 135° C. for 3 hours or more and subjected to rolling and vacuum drying processes so as to manufacture a positive electrode.

The 2032 type coin cell was manufactured by using the positive electrode and a lithium metal counter electrode. A separator having a thickness of about 16 μm and formed of a porous polyethylene (PE) film was interposed between the positive electrode and the lithium metal counter electrode, and an electrolytic solution was injected to manufacture the 2032 type coin cell. 1.1 M LiPF₆ solution was used the electrolytic solution. The 1.1 M LiPF₆ solution was prepared by adding LiPF₆ to a solvent in which ethylene carbonate (EC) and ethyl methyl carbonate (EMC) were mixed with a volume ratio of 3:5.

### MANUFACTURING EXAMPLES 2 to 6

Coin cells were manufactured using the manufacturing process described in Manufacturing Example 1 except that the positive electrode active materials obtained according to Examples 2 to 6 were used instead of the positive electrode active material obtained according to Example 1.

### COMPARATIVE MANUFACTURING EXAMPLES 1 to 4

### Manufacturing of Coin Cells

Coin cells were manufactured using the manufacturing process described in Manufacturing Example 1 except that the positive electrode active materials according to Comparative Examples 1 to 4 were used instead of the positive electrode active material according to Example 1.

### EVALUATION EXAMPLE 1

### Scanning Electron Microscope (SEM)

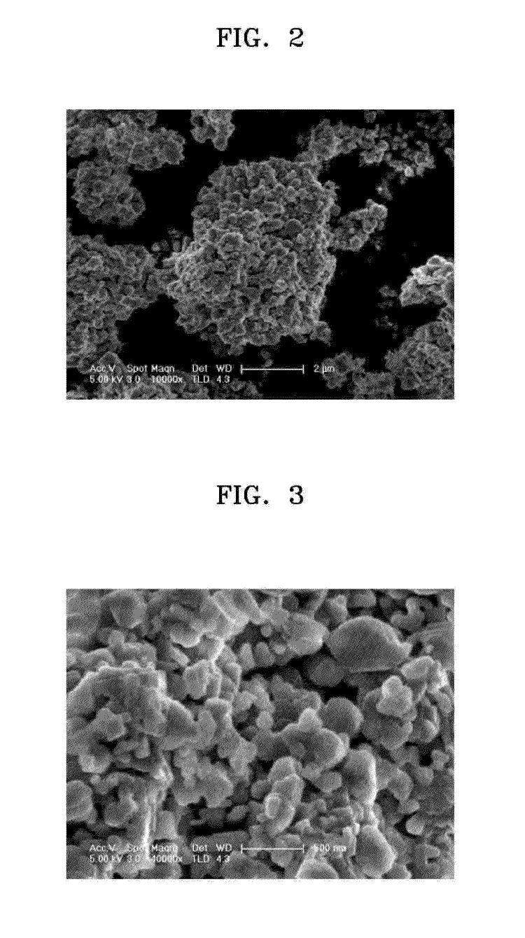

Positive electrode active materials obtained according to Example 5 and Comparative Example 1 were analyzed by using a SEM. Analysis results are shown in FIGS. 2 to 5. In the analysis, an SEM analyzer, S-4700 by Hitachi Corporation, was used.

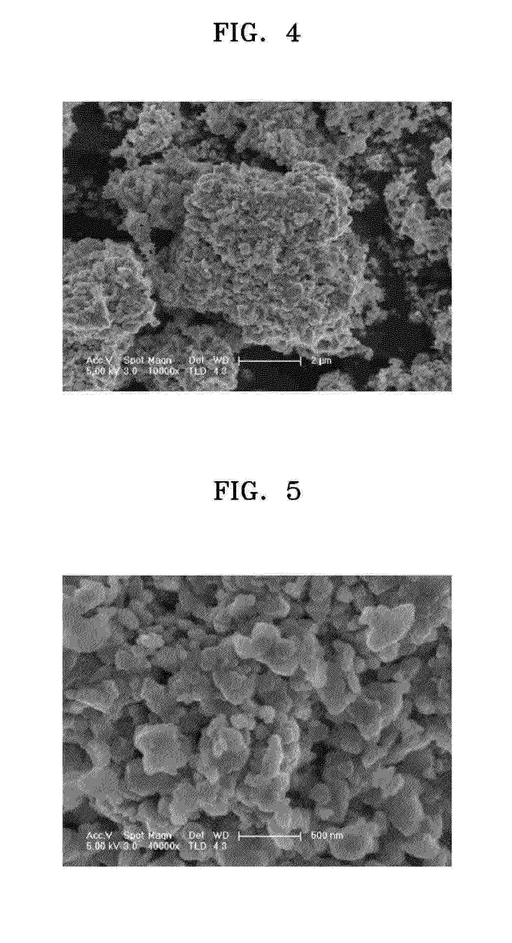

FIGS. 2 and 3 are SEM analysis photographs of the positive electrode active material of Example 5 that are taken at magnifications of 10,000 times and 40,000 times, and FIGS. 4 and 5 are SEM analysis photographs of the positive electrode active material of Comparative Example 1 that are taken at magnifications of 10,000 times and 40,000 times.

Average particle diameters of primary particles and secondary particles in the positive electrode active materials obtained according to Example 5 and Comparative Example 1 were measured from SEM analysis photographs of FIGS. 2 to 5. The measured average particle diameters of the primary and secondary particles are shown in Table 1 below:

TABLE 1

| | | Average particle diameter |
|---|---|---|
| | Average particle diameter | for secondary particles |
| Classification | for primary particles (nm) | (nm) |
| Example 5 | 10 to 300 | 3 to 5 |
| Comparative | 50 to 200 | 3 to 5 |
| Example 1 | | |

Further, as shown in the analysis results, the secondary particles of the positive electrode active material according to Example 5 exhibited the same amorphous state as that of the positive electrode active material of Comparative Example 1.

### EVALUATION EXAMPLE 2

### X-ray Diffraction Analysis

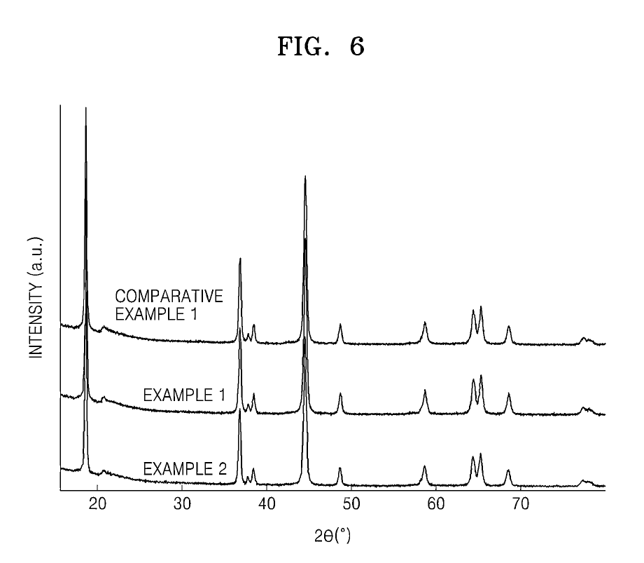

X-ray diffraction (XRD) analysis using Cu Ka was performed on the positive electrode active materials of Examples 1 and 3 and the positive electrode active material of Comparative Example 1, and results of the XRD analysis are illustrated in FIG. 6. The XRD analysis was conducted using a Rigaku RINT2200HF+ diffractometer using Cu Ka radiation (1.540598 Å).

Referring to FIG. 6, chromium-containing positive electrode active materials according to Examples 1 and 3 exhibited XRD patterns that were almost identical to that according to Comparative Example 1. The analysis results showed that an additional phase was not formed by chromium.

In addition, lattice constants (a) and (c), and V were calculated using the XRD analysis results as shown Table 2 below:

TABLE 2

Lattice constant

| | | | | Unit cell's |
|---|---|---|---|---|
| Classification | a (Å) | c (Å) | c/a | volume V (Å³) |
| Example 1 | 2.85515 | 14.2411 | 4.988 | 100.54 |
| Example 3 | 2.85767 | 14.2510 | 4.987 | 100.79 |

Referring to Table 2, it could be seen that the lattice constants (a) increased as the content of chromium increased. It could be determined from the numerical value range of the lattice constant (a) whether chromium was contained in the positive electrode active materials.

### EVALUATION EXAMPLE 3

### ICP Analysis

An ICP analysis was performed on the positive electrode active materials of Examples 1 to 3 and Comparative Example 1. Jobin Yvon by HORIBA Scientific was used as an analyzer when performing the ICP analysis.

ICP analysis results are shown Table 3 below:

TABLE 3

| | Ni | Co | Mn | Li | Cr | Li | Ni | Co | Mn | Cr |
|---|---|---|---|---|---|---|---|---|---|---|
| Classification | Wt. % | | | | | Mol % | | | | |
| Comparative | 11.0 | 11.2 | 30.7 | 9.1 | — | 1.40 | 19.95 | 20.23 | 59.82 | — |
| Example 1 (0% | (±0.03) | (±0.02) | (±0.35) | (±0.0001) | | | | | | |
| by mole of Cr) | | | | | | | | | | |
| Example 1 (3% | 10.7 | 10.6 | 29.8 | 9.0 | 1.4 | 1.39 | 19.55 | 19.42 | 58.22 | 2.82 |
| by mole of Cr) | (±0.02) | (±0.03) | (±0.10) | (±0.07) | (±0.003) | | | | | |
| Example 3 (10% | 9.9 | 9.8 | 27.2 | 8.5 | 4.1 | 1.34 | 18.48 | 18.26 | 54.59 | 8.67 |
| by mole of Cr) | (±0.10) | (±0.01) | (±0.04) | (±0.05) | (±0.02) | | | | | |

Referring to Table 3, the existence and content of chromium could be confirmed through the ICP analysis.

### EVALUATION EXAMPLE 4

### Charge/Discharge Test

### 1) Manufacturing Examples 3 to 5 and Comparative Manufacturing Examples 1 to 4

Charge/discharge characteristics of coin cells manufactured according to Manufacturing Examples 3 to 5 and Comparative Manufacturing Examples 1 to 4 were evaluated using a charging/discharging apparatus (Model No.: TOYO-3100 by TOYO Corporation, Japan).

One cycle of charge/discharge was first conducted at 0.1 C on the coin cells that had been manufactured in the Manufacturing Examples 3 to 5 and the Comparative Manufacturing Examples 1 to 4 to proceed with the formation of the coin cells. Thereafter, one cycle of charge/discharge was performed at 0.2 C on the coin cells to check initial charge/discharge characteristics of the coin cells, and cycle characteristics of the coin cells were examined while repeating 40 cycles of charge/discharge of the coin cells at 1 C. Charging of the coin cells was performed in a constant current (CC) mode and then in a constant voltage (CV) mode and was cut off at 0.01 C. Discharging of the coin cells was performed in CC mode and was cut off if the voltages thereof reduced from 4.6 V to about 2.45 V.

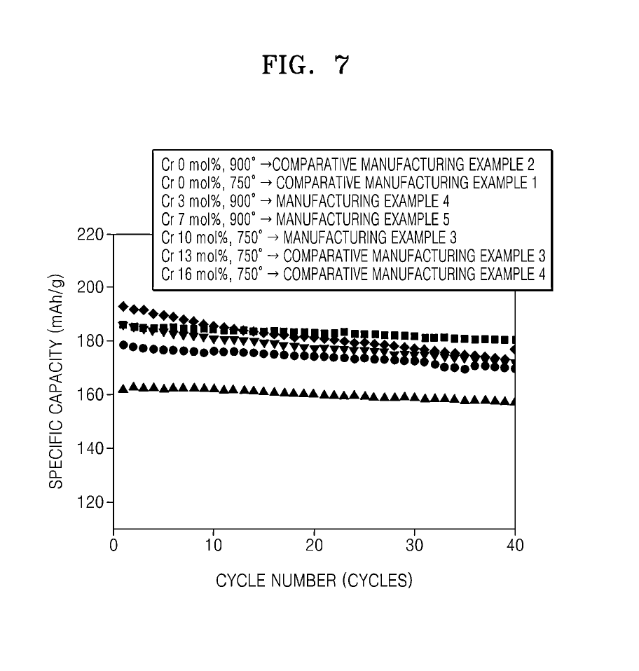

Evaluation results of the charge/discharge characteristics are shown in FIG. 7. FIG. 7 is a graph showing specific capacity variations according to cycle repetition.

Referring to FIG. 7, it could be confirmed that the coin cells of the Manufacturing Examples 3 to 5 exhibited the same specific capacity characteristic levels as those of the Comparative Manufacturing Examples 1 to 4, and exhibited more improved specific capacity characteristics than those of Comparative Manufacturing Examples 3 and 4.

### 2) Manufacturing Examples 1 to 3 and Comparative Manufacturing Examples 1 to 4

Charge/discharge characteristics of coin cells manufactured according to Manufacturing Examples 1 to 3 and Comparative Manufacturing Examples 1 to 4 were evaluated using a charging/discharging apparatus (Model No.: TOYO-3100 by TOYO Corporation, Japan).

One cycle of charge/discharge was first conducted at 0.1 C on the coin cells that had been manufactured in the Manufacturing Examples 1 to 3 and the Comparative Manufacturing Examples 1 to 4 to proceed with the formation of the coin cells. Thereafter, one cycle of charge/discharge was performed at 0.2 C on the coin cells to check initial charge/discharge characteristics of the coin cells, and cycle characteristics of the coin cells were examined while repeating 40 cycles of charge/discharge of the coin cells at 1 C. Charging of the coin cells was performed in a CC mode and then in a CV mode and was cut off at 0.01 C. Discharging of the coin cells was performed in a CC mode if the voltages of the coin cells reduced from 4.6 V to 2.45 V.

One-cycle charge capacity, discharge capacity, and initial charge/discharge efficiency were obtained from the charge/discharge characteristic analysis results as shown in Table 4 below.

(1) Initial Charge/Discharge Efficiency (I.C.E)

Initial charge/discharge efficiency (I.C.E) values were calculated using Equation 1 below:

Initial charge/discharge efficiency [%]=[1^{st} cycle discharge capacity/1^{st} cycle charge capacity]×100 [EQUATION 1]

### (2) Charge Capacity and Discharge Capacity

Charge capacity and discharge capacity at the first cycle were measured.

TABLE 4

| | | Discharge | |
|---|---|---|---|
| | Charge capacity | capacity | |
| Classification | (mAh/g) | (mAh/g) | I.C.E (%) |
| Manufacturing Example 1 | 306 | 261 | 85.3 |
| (Cr 3 mol %, 750° C.) | | | |
| Manufacturing Example 2 | 296 | 246 | 83.1 |
| (Cr 7 mol %, 750° C.) | | | |
| Manufacturing Example 3 | 279 | 222 | 79.4 |
| (Cr 10 mol %, 750° C.) | | | |
| Comparative Manufacturing | 309 | 263 | 84.9 |
| Example 1 | | | |
| (Cr 0 mol %, 750° C.) | | | |
| Comparative Manufacturing | 306 | 252 | — |
| Example 2 | | | |
| (Cr 0 mol %, 900° C.) | | | |
| Comparative Manufacturing | 272.5 | 214 | 78.5 |
| Example 3 | | | |
| (Cr 13 mol %, 750° C.) | | | |
| Comparative Manufacturing | 262.5 | 201 | 76.6 |
| Example 4 | | | |
| (Cr 16 mol %, 750° C.) | | | |

Referring to Table 4, it could be seen that the coin cells of Manufacturing Examples 1 to 3 had more improved initial discharge efficiency values than those of Comparative Manufacturing Example 1.

### 3) Manufacturing Examples 1 to 3 and Comparative Manufacturing Examples 1, 3, and

Charge/discharge characteristics of coin cells manufactured according to the Manufacturing Examples 1 to 3 and the Comparative Manufacturing Examples 1, 3, and 4 were evaluated using a charging/discharging apparatus (Model No.: TOYO-3100 by TOYO Corporation, Japan).

One cycle of charge/discharge was first conducted at 0.1 C on the coin cells that had been manufactured in the Manufacturing Examples 1 to 3 and the Comparative Manufacturing Examples 1, 3, and 4 to proceed with the formation of the coin cells. Thereafter, one cycle of charge/discharge was performed at 0.2 C on the coin cells to check initial charge/discharge characteristics of the coin cells, and voltage variations of the coin cells were examined while repeating 40 cycles of charge/discharge of the coin cells at 1 C. Charging of the coin cells was performed in a CC mode and then in a CV mode, and was cut off at 0.01 C. Discharging of the coin cells was performed in a CC mode and was cut off if the voltages of the coin cells reduced from 4.6 V to 2.45 V.

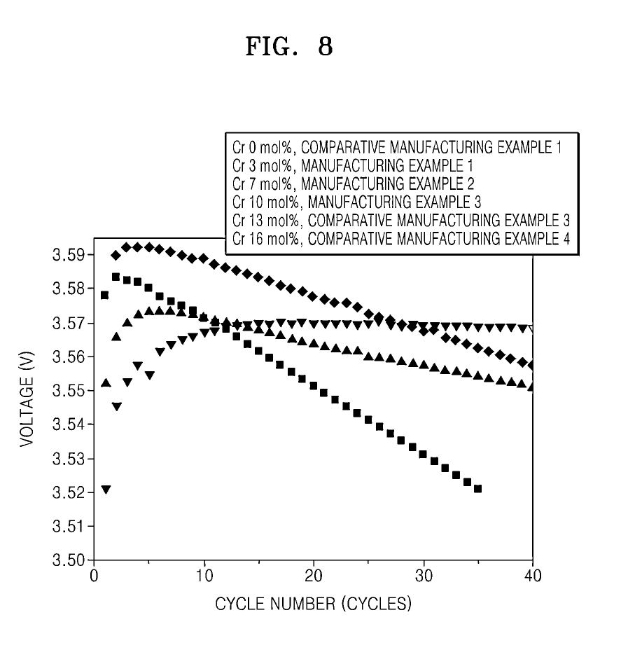

The voltage variations are illustrated in FIG. 8.

Referring to FIG. 8, it could be confirmed that nominal voltage decreases were more inhibited in the coin cells of Manufacturing Examples 1 to 3 than in the coin cells of Comparative Manufacturing Examples 1, 3, and 4.

### EVALUATION EXAMPLE 5

### Rate Characteristics

After the coin cells that had respectively been manufactured in the Manufacturing Examples 1 to 3 and the Comparative Manufacturing Examples 1 to 4 were charged under conditions of a constant current (0.1 C) and a constant voltage (1.0 V, 0.01 C cut-off), the charged coin cells were left to sit for 10 minutes. Then, the charged coin cells were discharged until the voltages thereof became 2.5 V under constant current conditions (0.1 C, 0.2 C, 0.33 C, 1 C, 2 C and 3 C), and rate discharge characteristics of the respective discharged coin cells were evaluated. Evaluation results are shown in Table 5 below.

Rate discharge characteristics of the coin cells of the Manufacturing Examples 1 to 3 and the Comparative Manufacturing Examples 1 to 4 may be calculated by Equation 2 below:

Rate discharge characteristics (%)=(discharge capacity when discharging a cell at a rate of 1 C, 2 C or 3 C)/(discharge capacity when discharging the cell at a rate of 0.1 C)×100 [EQUATION 2]

TABLE 5

| | Rate characteristics (%) | | |
|---|---|---|---|
| Classification | 1D/0.1D | 2D/0.2D | 3D/0.33D |
| Comparative Manufacturing | 79 | — | — |
| Example 2 | | | |
| (Cr 0 mol %, 900° C.) | | | |
| Comparative Manufacturing | 80 | — | — |
| Example 1 | | | |
| (Cr 0 mol %, 750° C.) | | | |
| Manufacturing Example 1 | 79 | 78 | 75 |
| (Cr 3 mol %, 750° C.) | | | |
| Manufacturing Example 2 | 80 | 79 | 75 |
| (Cr 7 mol %, 750° C.) | | | |
| Manufacturing Example 3 | 83 | 77 | 71 |
| (Cr 10 mol %, 750° C.) | | | |
| Comparative Manufacturing | — | 76 | 70 |
| Example 3 | | | |
| (Cr 13 mol %, 750° C.) | | | |
| Comparative Manufacturing | — | 76 | 68 |
| Example 4 | | | |
| (Cr 16 mol %, 750° C.) | | | |

In Table 5, 0.2 D, 0.33 D, 1 D, 2 D and 3 D refer to rate discharge characteristics obtained when discharging the coin cells under constant current conditions (0.1 C, 0.2 C, 0.33 C, 1 C, 2 C and 3 C), respectively.

Referring to Table 5, it could be seen that the coin cells of Manufacturing Examples 1 to 3 had improved rate discharge characteristics as compared with those of the coin cells of Comparative Manufacturing Examples 1 to 4, or had almost the same rate discharge characteristic levels as those of the coin cells of Comparative Manufacturing Examples 1 to 4.

### EVALUATION EXAMPLE 6

### Charge and Discharge Capacities

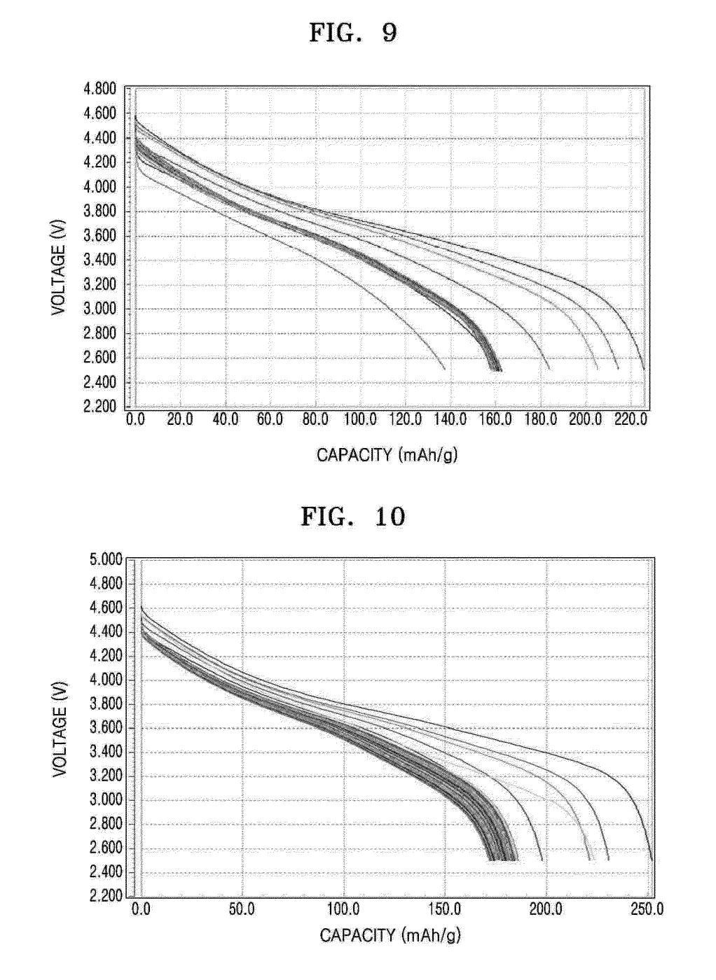

After the coin cells of Manufacturing Example 3 and Comparative Manufacturing Example 1 were charged at 0.1 C and 4.3 V and then discharged at 0.1 C and 3.0 V, charge and discharge capacities of the charged and discharged coin cells were evaluated. Evaluation results are illustrated in FIGS. 9 to 12.

FIGS. 9 and 10 show respectively show voltage-capacity variation curves obtained while the coin cells of Manufacturing Example 3 and Comparative Manufacturing Example 1 were used in cycles.

The dQ/dV versus voltage curves at an initial 0.2 c-rate of the coin cells of the Manufacturing Example 3 and the Comparative Manufacturing Example 1 were evaluated. In Comparative Manufacturing Example 1 in which Cr is not added, the peaks gradually decreased, and the known reason for this is phase transition in LiMn₂O₄. The peaks decreased less in Manufacturing Example 3 in which Cr was added as compared with the case of Comparative Manufacturing Example 1 in which Cr was not added, because the phase transition into LiMn₂O₄ was inhibited by characteristics of chromium having various oxidation states.

A lithium secondary battery which not only improves lifetime characteristics, but also inhibits a voltage reduction phenomenon may be manufactured.

While this disclosure has been described in connection with what is presently considered to be practical exemplary embodiments, it is to be understood that the invention is not limited to the disclosed embodiments and is intended to cover various modifications and equivalent arrangements included within the spirit and scope of the appended claims. Therefore, the aforementioned embodiments should be understood to be exemplary but not limiting the present invention in any way. In the present disclosure, the terms “Example” and “Comparative Example” are used to identify a particular example or experimentation and should not be interpreted as admission of prior art.

What is claimed is:

1. A positive electrode active material comprises a compound represented by Formula 1 and about 3% by mole to about 10% by mole of chromium:
xLi₂MnO₃-(1−x)Li_{y}Ni_{A}Mn_{B}Co_{C}M_{D}O₂ [Formula 1]
wherein 0<x≦0.8, 0.7≦y≦1.3, 0<A≦0.5, 0<B≦0.8, 0<C≦0.5, and 0≦D≦0.20, and M is at least one metal selected from the group consisting of titanium (Ti), vanadium (V), iron (Fe), copper (Cu), aluminum (Al), magnesium (Mg), zirconium (Zr), and boron (B).

2. The positive electrode active material of claim 1, wherein 0<x≦0.5, 0.9≦y≦1.1, 0<A≦0.44, 0<B≦0.33, 0<C≦0.33, and 0≦D≦0.10 in Formula 1.

3. The positive electrode active material of claim 1, wherein 0.33≦A≦0.44, 0.32≦B≦0.33, 0.24≦C≦0.33, and 0≦D≦0.10.

4. The positive electrode active material of claim 1, wherein the compound represented by Formula 1 is 0.5Li₂MnO₃-0.5LiNi_{0.44}Co_{0.24}Mn_{0.32}O₂ or 0.4Li₂MnO₃-0.6LiNi_{0.33}Co_{0.33}Mn_{0.33}O₂.

5. The positive electrode active material of claim 4, wherein the compound represented by Formula 1 is 0.4Li₂MnO₃-0.6LiNi_{0.33}Co_{0.33}Mn_{0.33}O₂.

6. The positive electrode active material of claim 5, comprising about 3% by mole of chromium.

7. The positive electrode active material of claim 5, comprising about 7% by mole of chromium.

8. The positive electrode active material of claim 5, comprising about 10% by mole of chromium.

9. The positive electrode active material of claim 1, wherein the positive electrode active material has a layered lattice structure with equal lattice constants (a) and (b) between about 2.85300 Å to about 2.85900 Å.

10. The positive electrode active material of claim 1, comprising primary particles having an average particle diameter from about 10 nm to about 300 nm.

11. The positive electrode active material of claim 1, comprising secondary particles having an average particle diameter from about 3 μm to about 5 μm.

12. A method of preparing a positive electrode active material, the method comprising:
mixing a composite precursor of Formula 2, a lithium compound, and a chromium compound; and
NiₐMn_{b}Co_{c}M_{d}(OH)₂ [Formula 2]
wherein 0<a≦0.5, 0<b≦0.8, 0<c≦0.5, and 0≦d≦0.20, and M is at least one metal selected from the group consisting of titanium (Ti), vanadium (V), iron (Fe), copper (Cu), aluminum (Al), magnesium (Mg), zirconium (Zr), and boron (B); and
heat-treating the mixture to obtain the positive electrode active material comprising a compound represented by Formula 1 and about 3% by mole to about 10% by mole of chromium:
xLi₂MnO₃-(1−x)Li_{y}Ni_{A}Mn_{B}Co_{C}M_{D}O₂ [Formula 1]
wherein 0<x≦0.8, 0.7≦y≦1.3, 0<A≦0.5, 0<B≦0.8, 0<C≦0.5, and 0≦D≦0.20, and M is one or more metals selected from the group consisting of titanium (Ti), vanadium (V), iron (Fe), copper (Cu), aluminum (Al), magnesium (Mg), zirconium (Zr), and boron (B).

13. The method of claim 12, the composite precursor represented by Formula 2 is prepared by the method comprising:
mixing a nickel precursor, a cobalt precursor, a manganese precursor, a metal (M) precursor, and a solvent to prepare a precursor mixture; and
mixing the precursor mixture with a base and performing a coprecipitation reaction on a resulting mixture.

14. The method of claim 12, wherein the chromium compound is at least one of chromic nitrate, chromium chloride, and chromium oxide.

15. The method of claim 14, wherein the mixture containing the precursor mixture and the base has a pH value range from about 7 to about 9.

16. The method of claim 15, wherein the mixture containing the precursor mixture and the base has a pH value of about 8.

17. The method of claim 12, wherein the heat-treating of the mixture is conducted at a temperature from about 700° C. to about 950° C.

18. The method of claim 12, wherein the heat-treating of the mixture is conducted at a temperature from about 750° C. to about 900° C.

19. A positive electrode for a lithium secondary battery, the positive electrode comprising the positive electrode active material of claim 1.

20. A lithium secondary battery comprising:
a positive electrode;
a negative electrode; and
a separator disposed between the positive electrode and the negative electrode, wherein the positive electrode is the positive electrode for a lithium secondary battery of claim 19.
